(19) United States
(12) Patent Application Publication
(10) Pub. No.: US 2026/0189746 A1
(43) Pub. Date: Jul. 2, 2026

(54) ELECTRONIC APPARATUS AND CONTROL METHOD THEREOF

(71) Applicant: SAMSUNG ELECTRONICS CO., LTD., Suwon-si (KR)

(72) Inventors: Jongin LEE, Suwon-si (KR); Sehyun KIM, Suwon-si (KR); Donghwa JEONG, Suwon-si (KR); Minhyo JUNG, Suwon-si (KR); Yeonwoo KIM, Suwon-si (KR); Donguk KIM, Suwon-si (KR)

(73) Assignee: SAMSUNG ELECTRONICS CO., LTD., Suwon-si (KR)

(21) Appl. No.: 19/464,222

(22) Filed: Jan. 29, 2026

Related U.S. Application Data
(63) Continuation of application No. PCT/KR2025/022230, filed on Dec. 18, 2025.

(30) Foreign Application Priority Data
Jan. 2, 2025 (KR) 10-2025-0000332

(51) Int. Cl. H04N 21/431

(52) U.S. Cl. CPC H04N 21/4316

(57) ABSTRACT

An electronic apparatus including a display, memory storing at least one instruction, and a processor. The processor is configured to, based on execution of the at least one instruction, control the display to output a home user interface (UI) including a recent screen area displaying a video, based on a user input, and based on an indicator being associated with the recent screen area during a predetermined time while the video is being played in the recent screen area, control the display to output, in an area broader than the recent screen area, a playback screen corresponding to the video played in the recent screen area, and based on the indicator being associated with the recent screen area during the predetermined time while an image corresponding to the video is being output in the recent screen area, control the display to maintain the output of the home UI.

### CROSS-REFERENCE TO RELATED APPLICATION

This application is a continuation application is a continuation application, under 35 U.S.C. § 111(a), of international application No. PCT/KR 2025/022230, filed Dec. 18, 2025, which claims priority under 35 U.S.C. § 119 to Korean Patent Application No. 10-2025-0000332, filed Jan. 2, 2025, the disclosures of which are incorporated herein by reference in their entireties.

### BACKGROUND

### 1. Field

The disclosure relates to an electronic apparatus and a control method thereof.

### 2. Description of Related Art

Recently, smart devices that support various functions such as execution of applications, streaming, games, web browsing, etc. as well as TV viewing are being developed and distributed.

A smart device can provide a user interface (UI) that can show functions that a user can use at once. Such a UI is generally referred to as a home UI. In case a user displays a home UI while viewing a screen of a specific application, a recent screen area that displays the screen of the application that was being executed may be provided on the home UI.

On the home UI, the user can select a content that the user wants, or select a desired function. Meanwhile, there is a case wherein, if focusing is maintained on the recent screen area during a specific time or longer while the home UI is displayed, the corresponding application is automatically executed and a video is played. However, sudden playback of the video while the user could not expect it in advance may rather cause inconvenience to the user.

Accordingly, there is a rising need for a technology that enables more effective use of home UI.

### SUMMARY

According to at least one embodiment of the disclosure, an electronic apparatus includes a display, memory to store at least one instruction, and a processor, based on execution of the at least one instruction, control the display to output a home user interface (UI) including a recent screen area displaying a video, based on a user input, and based on an indicator being associated with the recent screen area during a predetermined time while the video is being played in the recent screen area, control the display to output, in an area broader than the recent screen area, a playback screen corresponding to the video played in the recent screen area, and based on the indicator being associated with the recent screen area during the predetermined time while an image corresponding to the video is being output in the recent screen area, control the display to maintain the output of the home UI.

The processor may control the display to output a received video, and based on receiving the user input while a playback screen corresponding to the received video is being output, control the display to output the home UI in the area broader than the recent screen area and output the playback screen corresponding to the received video in the recent screen area, and based on receiving the user input while a still screen corresponding to the received video is being output, control the display to output the home UI in the area broader than the recent screen area and output the still screen corresponding to the received video or a replacement image in the recent screen area.

The processor may store a plurality of image frames within a specific time corresponding to the received video in the memory while the received video is being output, and based on receiving the user input, identify whether the received video is played based on the plurality of image frames stored in the memory.

The processor may store audio data within a specific time among the audio data included in the received video in the memory while the received video is being output, and based on receiving the user input, identify whether the received video is played based on the audio data stored in the memory.

The processor may, while identifying whether the received video is played, control the display to output the replacement image corresponding to the received video in the recent screen area, and based on whether the received video is identified to be played, control the display to output the playback screen corresponding to the received video in the recent screen area or output the still screen or the replacement image corresponding to the received video.

The processor may, based on a function corresponding to screen size adjustment being unsupported by an application related to playback of the received video not supporting a function corresponding to screen size adjustment, control the display to output the home UI based on the user input while the playback screen corresponding to the received video is being output through the application, and control the display to output an image corresponding to the application in the recent screen area.

The processor may, while the image corresponding to the application is being output i the recent screen area included in the home UI, based on the indicator being associated with the recent screen area during the predetermined time, control the display to output the playback screen corresponding to the received video in the area broader than the recent screen area through the application.

The replacement image may be an image related to at least one of a logo of a source that provides the received video, a text, a graphic image corresponding to the source, or detailed information corresponding to the source or the video.

According to at least one embodiment of the disclosure, a control method of an electronic apparatus includes outputting a home UI including a recent screen area displaying a video, based on a user input, based on an indicator being associated with the recent screen area during a predetermined time while the video is being played in the recent screen area, outputting, in an area broader than the recent screen area, a playback screen corresponding to the video played in the recent screen area, and based on the indicator being associated with the recent screen area during the predetermined time while an image corresponding to the video is being output in the recent screen area, maintaining the output of the home UI.

The control method may include outputting a received video, and the outputting the home UI may include, based on receiving the user input while a playback screen corresponding to the received video is being output, outputting the home UI in the area broader than the recent screen area and outputting the playback screen corresponding to the received video in the recent screen area, and based on receiving the user input while a still screen corresponding to the received video is being output, outputting the home UI in the area broader than the recent screen area and outputting the still screen corresponding to the received video or a replacement image in the recent screen area.

The outputting the home UI may further include storing a plurality of image frames within a specific time corresponding to the received video while the received video is being output, and based on receiving the user input, identifying whether the received video is played based on the stored plurality of image frames.

The outputting the home UI may further include storing audio data within a specific time among the audio data included in the received video while the received video is being output, and based on receiving the user input, identifying whether the received video is played based on the stored audio data.

The outputting the home UI may further include while identifying whether the received video is played, outputting the replacement image corresponding to the received video in the recent screen area, and based on whether the received video is identified to be played, outputting the playback screen corresponding to the received video in the recent screen area or outputting the still screen or the replacement image corresponding to the received video.

The control method may include outputting a received video, and the outputting the home UI may include based on a function corresponding to screen size adjustment being unsupported by an application related to playback of the received video, outputting the home UI based on the user input while the playback screen corresponding to the received video is being output through the application, and outputting an image corresponding to the application in the recent screen area.

The control method may further include, while the image corresponding to the application is being output in the recent screen area included in the home UI, based on the indicator being associated with the recent screen area during the predetermined time, outputting the playback screen corresponding to the received video in the area broader than the recent screen area through the application.

The replacement image is output in the recent screen area, the replacement image being related to at least one of a logo of a source that provides the video, a text, a graphic image corresponding to the source, or detailed information corresponding to the source or the video.

According to at least one embodiment of the disclosure, a non-transitory computer-readable recording medium including a program for executing a control method for an electronic apparatus, wherein the method includes outputting a home UI including a recent screen area displaying a video, based on a user input, based on an indicator being associated with the recent screen area during a predetermined time while the video is being played in the recent screen area, outputting, in an area broader than the recent screen area, a playback screen corresponding to the video played in the recent screen area, and based on the indicator being associated with the recent screen area during the predetermined time while an image corresponding to the video is being output in the recent screen area, maintaining the output of the home UI.

The control method may include outputting a received video, and the outputting the home UI may include, based on receiving the user input while a playback screen corresponding to the received video is being output, outputting the home UI in the area broader than the recent screen area and outputting the playback screen corresponding to the received video in the recent screen area, and based on receiving the user input while a still screen corresponding to the received video is being output, outputting the home UI in the area broader than the recent screen area and outputting the still screen corresponding to the received video or a replacement image in the recent screen area.

The outputting the home UI may further include storing a plurality of image frames within a specific time corresponding to the received video while the received video is being output, and based on receiving the user input, identifying whether the received video is played based on the stored plurality of image frames.

The outputting the home UI may further include storing audio data within a specific time among the audio data included in the received video while the received video is being output, and based on receiving the user input, identifying whether the received video is played based on the stored audio data.

### BRIEF DESCRIPTION OF THE DRAWINGS

FIGS. 1A and 1B are diagrams schematically illustrating an operation of an electronic apparatus according to at least one embodiment of the disclosure;

FIG. 2 is a block diagram schematically illustrating a configuration of an electronic apparatus according to at least one embodiment of the disclosure;

FIG. 3 is a block diagram for illustrating a detailed configuration of an electronic apparatus according to at least one embodiment of the disclosure;

FIGS. 4A, 4B, 4C to 4D are diagrams illustrating home UIs in various forms that are displayed according to a user input according to at least one embodiment of the disclosure;

FIGS. 5 to 6 are diagrams illustrating a case wherein an indicator is located on a recent screen area on a home UI according to at least one embodiment of the disclosure;

FIGS. 7 and 8 are diagrams illustrating a case wherein a user input was received according to at least one embodiment of the disclosure;

FIG. 9 is a diagram illustrating a case wherein an application related to playback of a video does not support a function corresponding to screen size adjustment according to at least one embodiment of the disclosure;

FIG. 10 is a flow chart illustrating a control method of an electronic apparatus according to at least one embodiment of the disclosure;

FIG. 11 is a flow chart for illustrating in detail a method of displaying a home UI including a recent screen area in an electronic apparatus according to at least one embodiment of the disclosure; and

FIG. 12 is a flow chart illustrating an operation of an electronic apparatus in case an indicator is located on a recent screen area of a home UI according to at least one embodiment of the disclosure.

### DETAILED DESCRIPTION

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or a plurality of “parts” may be integrated into at least one module and implemented as at least one processor (not shown), except “a module” or “a part” that needs to be implemented as specific hardware.

Further, in this specification, the term “user” may refer to a person who uses an electronic apparatus or an apparatus using an electronic apparatus (e.g.: an artificial intelligence electronic apparatus).

Hereinafter, an embodiment of the disclosure will be described in more detail with reference to the accompanying drawings.

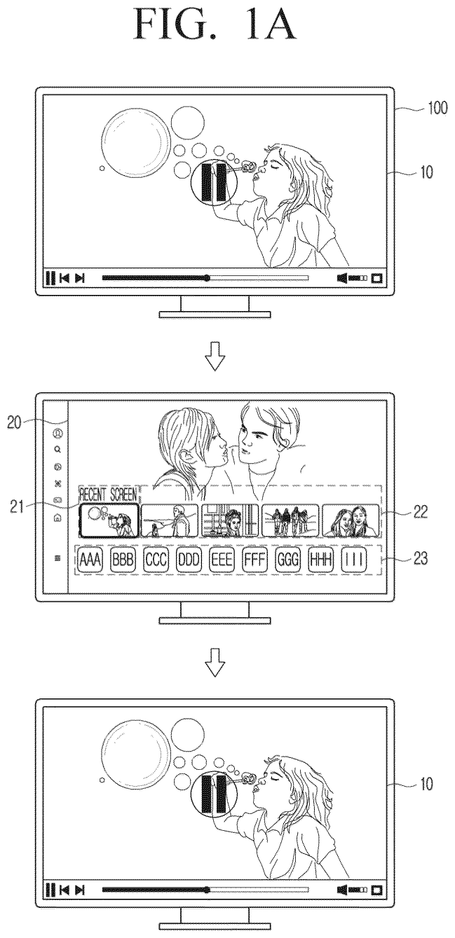

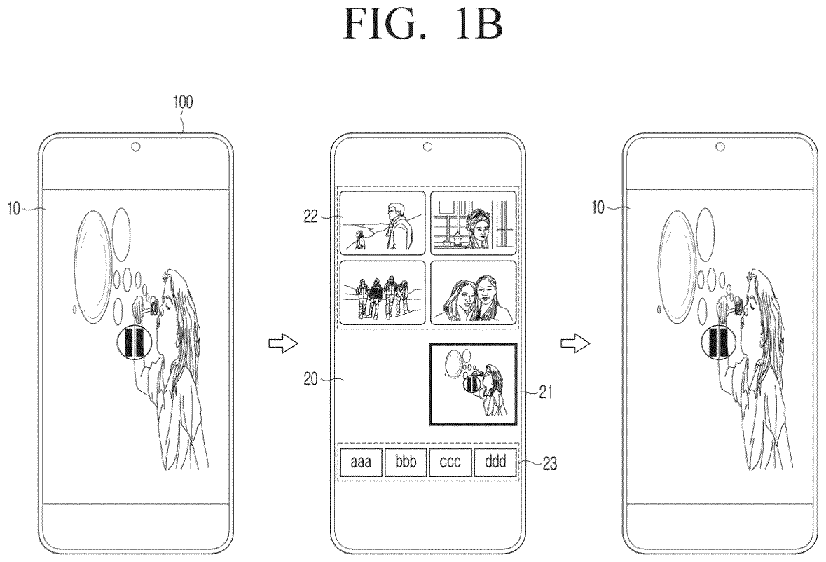

FIG. 1A is a diagram schematically illustrating an operation of an electronic apparatus according to at least one embodiment of the disclosure. In FIG. 1A, it was illustrated that the electronic apparatus 100 is a TV including a display, but the various embodiments of the disclosure may be implemented in electronic apparatuses in various forms as well as in a TV. Even if the electronic apparatus 100 does not include a display in itself, it may be implemented as an apparatus that is connected to an external display device separately provided and provides a video. As an example, the electronic apparatus 100 may be implemented in various forms such as a TV, a set-top box, a PC, a laptop PC, a smartphone, a tablet PC, a video wall, a kiosk, etc.

Referring to FIG. 1A, the electronic apparatus 100 may display an execution screen of an application or a video 10. The electronic apparatus 100 may receive video data from an external content source according to execution of the application, and decode the data and reproduce the video. Alternatively, the electronic apparatus 100 may reproduce a video provided from a web server to which the electronic apparatus 100 is connected, a media player, a cable station, a broadcasting station, etc.

The electronic apparatus 100 may receive a user input while outputting a playback screen corresponding to the video 10. A user input may be a control command or a control signal that is input into the electronic apparatus 100 according to the user's manipulation for controlling the operation of the electronic apparatus 100. As an example, a user input may include a command for displaying a home UI. In case the user selects a remote control or a home UI button provided on the body of the electronic apparatus 100 for checking the home UI, a user input including a command for displaying the home UI may be received at the electronic apparatus 100.

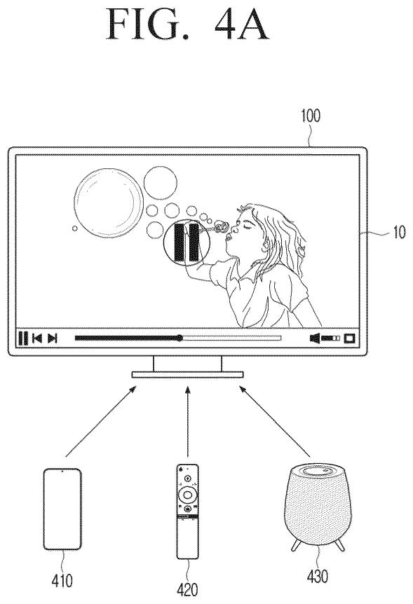

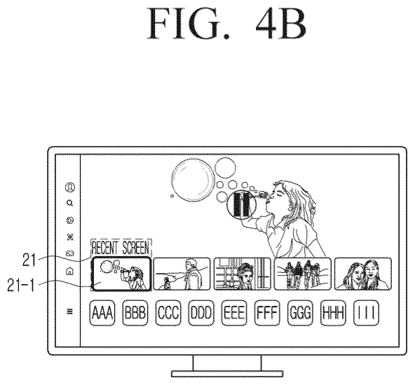

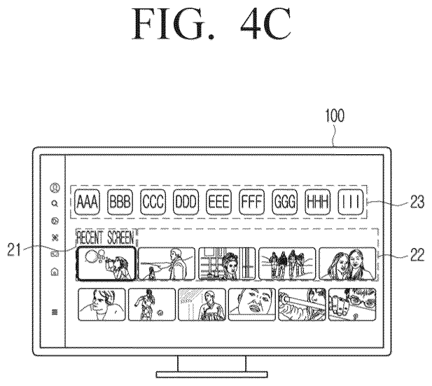

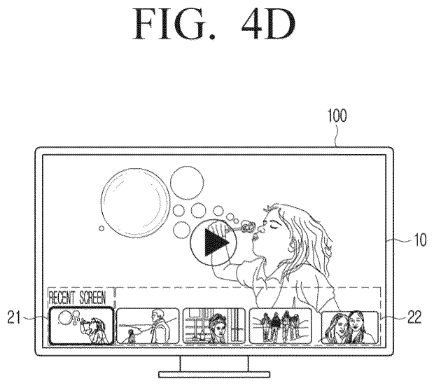

A method for the electronic apparatus 100 to receive a user input will be described below in FIG. 4. The user may input a command for displaying the home UI without stopping the video 10 while the video 10 is being played, or input a command for displaying the home UI after stopping the video 10. The feature of stopping the video may include a case of temporarily stopping the playback state.

When the electronic apparatus 100 receives the user input, the electronic apparatus 100 may convert the application or the video that was being executed into a background state. Some functions of the application or the video converted into the background state may be temporarily stopped or limited. The electronic apparatus 100 may replace the entire playback screen corresponding to the application or the video by the home UI 20 and display the home UI 20, or overlay the home UI 20 on a part of the playback screen and display it.

The background state may be described in various terms such as an inactivated state, a suspended state, or a hidden state, etc., but it will be described as a background state in the various embodiments of the disclosure.

In FIG. 1A, a state wherein the entire playback screen was replaced by the home UI 20 was illustrated. The configuration wherein at least one menu of the home UI is overlaid on a part of the playback screen will be described in detail again in FIG. 4B to FIG. 4D that will be described below.

When the electronic apparatus 100 receives the user input, the electronic apparatus 100 may output the home UI 20. The home UI 20 is a screen for showing various objects such as a screen provided from a content source connected to the electronic apparatus 100, a screen provided from an application installed on the electronic apparatus 100, and menus corresponding to the operations or functions of the electronic apparatus 100, etc. The home UI may alternatively be described in various ways such as a main screen, an application screen, a base screen, etc.

The home UI may consist of a plurality of display areas for displaying various kinds of screens or menus, etc. One of the plurality of display areas may be a recent screen area 21.

The recent screen area 21 is an area wherein information on a video that was being played before the home UI 20 was displayed or when the command for displaying the home UI was input is displayed.

The information on the video displayed in the recent screen area 21 may be a playback screen or a still screen corresponding to the video, the title of the video, or information on an application related to playback of the video. The recent screen area 21 may alternatively be described as a recent content area, a recent use area, a recent tile, etc.

The home UI 20 may include various display areas such as a recommendation area 22, an executable application area 23, a search area, a setting area, etc. other than the recent screen area 21.

Referring to FIG. 1A, the electronic apparatus 100 may display a thumbnail or an advertisement image corresponding to one of a plurality of contents included in the recommendation area 22 in the upper parts of the recent screen area 21 and the recommendation area 22. Alternatively, the electronic apparatus 100 may display information on a video corresponding to an area on which an indicator is located or information on an application related to playback of a video. However, the configuration and the arrangement of the home UI 20 illustrated in FIG. 1A merely fall under one embodiment, and the home UI 20 is not limited thereto, and may include various configurations and arrangements. An embodiment regarding the configuration and the arrangement of the home UI 20 will be explained in detail in FIG. 4.

The electronic apparatus 100 may locate an indicator on one area among a plurality of areas included in the home UI 20. Referring to FIG. 1A, the indicator is located on the recent screen area 21. The indicator may alternatively mean a focus, a focus highlight, a cursor, and a pointer. The indicator may mean a state wherein one area among a plurality of display areas on the home UI 20 is selected or emphasized as the user moved a focus or a cursor through an input device. In case the electronic apparatus 100 displays the indicator within the screen, the area on which the indicator is located may be a focused area. Alternatively, in case it becomes a state wherein one area can be selected according to a command for manipulating a direction without separate display of the indicator, the area may be the area on which the indicator is located.

The electronic apparatus 100 may display one area on which the indicator is located to be distinctive compared to the ambient areas. For example, the electronic apparatus 100 may display an area on which the indicator is located on the home UI 20 to be bigger than the other areas, or display the thickness of the rim of the area to be thick or display it in a different color. Alternatively, the electronic apparatus 100 may display a highlight on the background or the rim part of the area. Alternatively, the electronic apparatus 100 may display an execution screen of an application corresponding to the area on which the indicator is located with the aforementioned distinctive display. For example, in case the application corresponding to the area on which the indicator is located is an application related to playback of a video, the electronic apparatus 100 may display the area to be bigger than the other areas, and display a playback screen corresponding to the video together. In FIG. 1A, it was illustrated that the recent screen area 21 is focused and its rim is displayed to be thick unlike the other areas. Through this, the user can visually identify that the recent screen area 21 of the home UI 20 is the area wherein the indicator is currently located.

Meanwhile, the electronic apparatus 100 may receive an input corresponding to moving of the indicator from the user through a remote control, a touch pad, or an AI speaker, etc. The electronic apparatus 100 may move the area on which the indicator is located by receiving a signal corresponding to a button input of the remote control, or receive information on a tilt and a movement of the remote control that is measured when the remote control moves, and display such that the indicator is moved on the home UI 20. Alternatively, the electronic apparatus 100 may display the area on which the indicator is located by receiving the user's voice through the AI speaker.

While the indicator is located on one area, if the user selects a check button of the remote control or a check button provided on the electronic apparatus 100, etc., the electronic apparatus 100 identifies that the area on which the indicator is located was selected. If the user selects a direction manipulation button, the electronic apparatus 100 moves the indicator based on the button and displays it. While the indicator is located on another area by the movement, if the check button is selected, an application or a function corresponding to the area is executed, and a screen corresponding thereto may be displayed on the entire screen.

If a predetermined time passes while the indicator is located on one display area among the plurality of display areas on the home UI 20, the electronic apparatus 100 may identify that the display area was selected, and automatically execute an application or a function corresponding to the area.

For example, if the indicator is located on the recent screen area 21 for one minute or longer, the electronic apparatus 100 may convert a playback screen 21-1 of a content displayed in the recent screen area 21 to a foreground, and output it in an area broader than the recent screen area 21. Conversion to the foreground may alternatively be expressed as foreground resumption or playback. Hereinafter, the feature that the indicator is located on a specific area on the home UI 20 and a video is converted to a foreground and displayed will be referred to as ‘automatic Re-execution of a Video.’

However, there may be a case wherein automatic re-execution of a video fails. For example, an application or a video may end in a background state, or window memory of an application that was converted to a background may be deleted in a process of optimizing the memory. In this case, even if the recent screen area is focused during the predetermined time or longer, as there is no window memory for the video displayed in the recent screen area, the video may not be converted to a foreground. The electronic apparatus 100 may identify that automatic re-execution failed by the phenomenon that, even though the video was intended to be converted to a foreground, the state of the home UI is maintained or the entire screen is broken or displayed in a block color. The electronic apparatus 100 may store such a state in the memory, and in case such a state is repeated by a predetermined number of times or more, the electronic apparatus 100 may not attempt automatic re-execution for the application or the video.

FIG. 1B is a diagram illustrating a scene wherein the electronic apparatus 100 including a display in a form wherein the vertical length is longer than the horizontal length displays a home UI within the entire screen according to another embodiment of the disclosure.

The home UI displayed on the display in a form wherein the vertical length is longer than the horizontal length may be referred to as a vertical home UI from below, for the convenience of explanation.

However, the forms of the home UI 20 illustrated in FIG. 1A and FIG. 1B are merely an embodiment, and the disclosure is not limited thereto, and a UI in a different form may be displayed.

The electronic apparatus 100 may output a received video 10. The electronic apparatus 100 may output the video 10 received from an application related to playback of a video. In FIG. 1B, a case wherein the video 10 is output in a state wherein the aspect ratio was adjusted to match the aspect ratio of the display was illustrated, but in case the electronic apparatus 100 including a vertical type display displays a video of which horizontal length is longer, the video may be displayed only in a part of the display, and the remaining parts may be filled with a black screen.

When the electronic apparatus 100 receives a user input, the electronic apparatus 100 may output the home UI 20 including the recent screen area 21 in place of a playback screen or a still screen corresponding to the video 10. The electronic apparatus 100 may output the home UI 20 including the recent screen area 21, the recommendation area 22, and the executable application area 23. Referring to FIG. 1B, the electronic apparatus 100 may output the home UI 20 wherein the recommendation area 22 is arranged in the upper part, and the executable application area 23 is arranged in the lower part, and the recent screen area 21 is arranged between the recommendation area 22 and the executable application area 23. However, the arrangement of the plurality of display areas included in the home UI 20 in a vertical form illustrated in FIG. 1B is merely an embodiment, and the disclosure is not limited to FIG. 1B.

According to another embodiment, the electronic apparatus 100 may overlay the home UI 20 on a playback screen or a still screen corresponding to the video 10 and output it. According to still another embodiment, the electronic apparatus 100 may overlay a quick menu together with the recent screen area 21 on a playback screen or a still screen corresponding to the video 10, and output it. Detailed explanation regarding various embodiments will be described in FIG. 4B to FIG. 4D.

As overlapping explanation regarding the operations of the electronic apparatus 100 was described above, the explanation will be omitted.

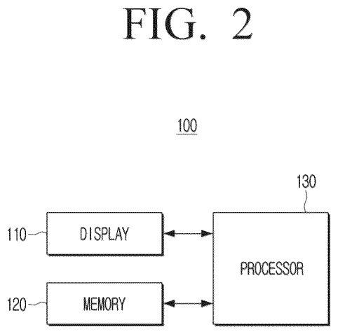

FIG. 2 is a block diagram schematically illustrating a configuration of the electronic apparatus 100 according to at least one embodiment of the disclosure.

The electronic apparatus 100 according to the disclosure is an apparatus that can output a video in the recent screen area 21 included in the home UI 20, and it may be implemented as an on-device on the electronic apparatus 100 including the display, or implemented on an external device connected with the electronic apparatus 100. Meanwhile, the electronic apparatus 100 may be implemented as various apparatuses such as a TV, a smartphone, a server, etc., but there is no special limitation on the type of the electronic apparatus 100.

As illustrated in FIG. 2, the electronic apparatus 100 according to the disclosure may include a display 110, memory 120, and a processor 130.

The display 110 may output video data by control by the processor 130. The display 110 may output a video stored in advance in the memory 120 by control by the processor 130. The display 110 may be implemented as a liquid crystal display (LCD) panel, organic light emitting diodes (OLED), etc., and depending on cases, the display 110 may also be implemented as a flexible display 110, a transparent display 110, etc. However, the display 110 according to the disclosure is not limited to specific types. In FIG. 2, it was illustrated as if the electronic apparatus 100 stores the display 110 in itself, but it may be interpreted that the disclosure includes not only a case wherein the display 110 is actually mounted on the electronic apparatus 100 (e.g., a TV, a kiosk, a smartphone, a laptop PC, a tablet PC, etc.), but also a case wherein the electronic apparatus 100 is connected with a separately provided display device (e.g., a monitor, a TV, a beam projector, an electronic blackboard, etc.) by various types of wired/wireless communication methods (e.g., a set-top box, a PC, a server, etc.).

According to one or more embodiments of the disclosure, the display 110 may display the home UI 20 and a playback screen corresponding to the video 10. Specifically, the display 110 may display a plurality of areas including the recent screen area 21 that displays information on the video that was being played.

In the memory 120, at least one instruction regarding the electronic apparatus 100 may be stored. Also, in the memory 120, an operating system (O/S) for operating the electronic apparatus 100 may be stored. In addition, in the memory 120, various types of software programs or applications for the electronic apparatus 100 to operate according to the various embodiments of the disclosure may be stored. Further, the memory 120 may be implemented as volatile memory such as static random access memory (S-RAM), dynamic random access memory (D-RAM), etc., non-volatile memory such as flash memory, read only memory (ROM), erasable programmable read only memory (EPROM), electrically erasable programmable read only memory (EEPROM), etc., a hard disk drive (HDD), or a solid state drive (SSD), etc.

Specifically, in the memory 120, various types of software modules for the electronic apparatus 100 to operate according to the various embodiments of the disclosure may be stored, and the processor 130 may control the operations of the electronic apparatus 100 by executing the various types of software modules stored in the memory 120. In other words, the memory 120 may be accessed by the processor 130, and reading/recording/correction/deletion/update, etc. of data by the processor 130 may be performed.

The memory 120 may be a component provided separately from the processor 130, or internal memory included inside the processor 130, or it may be used as a meaning including a memory card (not shown) (e.g., a micro SD card, a memory stick) mounted on the electronic apparatus 100 or an external hard drive, etc.

According to one or more embodiments of the disclosure, in the memory 120, data for a program or an application displayed on the home UI 20, image or audio data for a video being played, and information on an application providing a video may be stored. Also, an identification model that determines whether a video is played may be stored.

Other than the above, various types of information necessary within a range for achieving the purpose of the disclosure may be stored in the memory 120, and the information stored in the memory 120 may be updated as it is received from an external device or input by the user.

The processor 130 controls the overall operations of the electronic apparatus 100. Specifically, the processor 130 may be connected with the components of the electronic apparatus 100 including the display 110 and the memory 120, and control the overall operations of the electronic apparatus 100 by executing the at least one instruction stored in the memory 120 as described above.

The processor 130 may be implemented by various methods. For example, the processor 130 may include one or more of a central processing unit (CPU) processing digital signals, a micro controller unit (MCU), a micro processing unit (MPU), a controller, an application processor (AP) or a communication processor (CP), and an ARM processor, or may be defined by the terms. Also, the processor 130 may be implemented as a system on chip (SoC) having a processing algorithm stored therein or large scale integration (LSI), or in the form of a field programmable gate array (FPGA). The processor 130 may perform various functions by executing computer executable instructions stored in the memory 120.

The processor 130 controls the display 110 to display various screens based on execution of the at least one instruction stored in the memory 120.

As an example, the processor 130 controls the display 110 to output the home UI including the recent screen area based on a user input.

If a user input is received while a playback screen corresponding to a received video i being output, the processor 130 controls the display 110 to output the home UI in an area broader than the recent screen area and output a playback screen corresponding to the received video in the recent screen area. According to this, the user can keep viewing the content that the user was viewing on the home UI.

In contrast, if a user input is received while a still screen corresponding to a received video is being output, the processor 130 controls the display 110 to output the home UI in an area broader than the recent screen area and output a still screen or a replacement image corresponding to the received video in the recent screen area. The still screen may be an image frame on a time point when the video was stopped according to a command for temporary stop. The replacement image may include an image related to at least one of a logo of a source that provides the received video, a text, a graphic image corresponding to the source, or detailed information corresponding to the source or the video. The information on the replacement image may be stored in advance in the memory 120.

If the indicator is located on the recent screen area during the predetermined time while the video is being played in the recent screen area, the processor 130 may control the display 110 to output a playback screen corresponding to the video played in the recent screen area in an area broader than the recent screen area.

Alternatively, if the indicator is located on the recent screen area during the predetermined time while an image corresponding to the video is being output in the recent screen area, the processor 130 controls the display 110 to maintain the output of the home UI.

In case the user displayed the home UI after temporarily stopping the video, the user may not expect in advance a case wherein the video is played again. Accordingly, the processor 130 does not perform the automatic re-execution function in such a situation. In contrast, in case the user displayed the home UI while the video is being played, there may be an intent for searching another content or application, and thus the processor 130 performs the automatic re-execution function as described above.

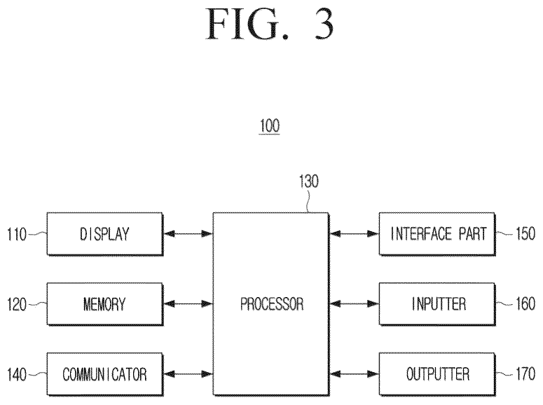

FIG. 3 is a block diagram for illustrating a detailed configuration of the electronic apparatus 100 according to at least one embodiment of the disclosure.

As illustrated in FIG. 3, the electronic apparatus 100 may not only include the display 110, the memory 120, and the processor 130, but may also further include a communicator 140, an interface part 150, an inputter 160, and an outputter 170. However, the components as illustrated in FIG. 2 and FIG. 3 are merely exemplary ones, and in implementing the disclosure, it is obvious that new components can be added in addition to the components as illustrated in FIG. 2 and FIG. 3, or some components can be omitted. As basic explanation of operations of the display 110, the memory 120, and the processor 130 among the components in FIG. 3 and detailed examples were described in FIG. 2, overlapping explanation will be omitted.

The communicator 140 includes circuitry, and may perform communication with an external device. Specifically, the processor 130 may receive various types of data or information from an external device connected through the communicator 140, or transmit various types of data or information to an external device.

The communicator 140 may include at least one of a Wi-Fi module, a Bluetooth module, a wireless communication module, an NFC module, or an ultra wide-band (UWB) module. Specifically, a Wi-Fi module and a Bluetooth module may perform communication by a Wi-Fi method and a Bluetooth method, respectively. In the case of using a Wi-Fi module or a Bluetooth module, various types of connection information such as an SSID, etc. is transmitted and received first, and connection of communication is performed by using the information, and various types of information can be transmitted and received thereafter.

Also, a wireless communication module may perform communication according to various communication standards such as IEEE, Zigbee, 3rd Generation (3G), 3rd Generation Partnership Project (3GPP), Long Term Evolution (LTE), 5th Generation (5G), etc. In addition, an NFC module may perform communication by a near field communication (NFC) method using a 13.56 MHz band among various RF-ID frequency bands such as 135 kHz, 13.56 MHz, 433 MHz, 860-960 MHz, and 2.45 GHz. Further, a UWB module can correctly measure a Time of Arrival (ToA) which is the time that a pulse reaches a target, and an Angle of Arrival (AoA) which is a pulse arrival angle in a transmission device through communication between UWB antennas, and accordingly, the UWB module can perform precise distance and location recognition in an error range of within scores of cm indoors.

In the various embodiments of the disclosure, the processor 130 may receive a user input through the communicator 140. The processor 130 may receive a signal related to a command for displaying the home UI that was input by the user from an external device. The processor 130 may receive data such as an image, audio, subtitles, etc. for a video from an external server that provides the video through the communicator 140.

Also, in case a model that determines whether a video is played is included in an external server, the processor 130 may control the communicator 140 to transmit an image frame or audio data of a video to the external server including the model, and receive information on whether the video is played from the external server. Other than the above, the processor 130 may receive various types of information/data such as information on the type, the title, and the subtitles of the video, etc. from the external server.

The interface part 150 may transmit and receive video data and/or audio data in a relation between an external device. Specifically, the interface part 150 may include an input port that can receive video data and/or audio data from an external device, and an output port that can transmit video data and/or audio data to an external device. In particular, in case the interface part 150 can transmit and receive both of video data and audio data, an input/output port that can transmit and receive video data and audio data may be implemented separately. The interface part 150 may connect the electronic apparatus 100 and an external device via wire through a cable, or may connect the electronic apparatus 100 and an external device wirelessly.

For example, the interface part 150 may include a high-definition multimedia interface (HDMI) module, a universal serial bus (USB) module, etc. An HDMI module is one of digital video/audio interface specifications by a non-compressive method, and it may provide an interface between the electronic apparatus 100 and an external device providing a content (i.e., an external content source). A USB module may provide a communication system between the electronic apparatus 100 and an external device providing a content by using a pre-defined input/output standard protocol. Other than the HDMI module and the USB module, the interface part 150 can obviously be implemented as various modules for providing inputs/outputs of video/voice data between the electronic apparatus 100 and an external device such as a display port (DP) module, an RGB module, a digital visual interface (DVI) module, and a thunderbolt module, etc. other than the HDMI module and the USB module.

In particular, in one or more embodiments, the processor 130 may receive data for a content from an external device, and control the display 110 to display the content based on the received data. Other than the above, the interface part 150 may transmit and receive various types of information/data including a control signal between the electronic apparatus 100 and an external device in the various embodiments according to the disclosure.

Meanwhile, in FIG. 2 and FIG. 3, it is illustrated that the display 110 is included in the electronic apparatus 100, but the disclosure is not necessarily limited thereto. In other words, the electronic apparatus 100 may transmit a video signal that can be output on an external display connected with the electronic apparatus 100. For example, the electronic apparatus 100 may constitute a video signal transmitted to the external display so that the home UI including the plurality of areas can be output on the external display. However, hereinafter, it will be described that the electronic apparatus 100 displays the home UI for the convenience of explanation.

The inputter 160 includes circuitry, and the processor 130 may receive a user command for controlling the operations of the electronic apparatus 100 through the inputter 160. Specifically, the inputter 160 may include a microphone, a keyboard inputter, and a remote control signal receiver, etc. Also, the inputter 160 may be implemented in a form of being included in the display 110 as a touch screen. In particular, the microphone may receive a voice signal, and convert the received voice signal into an electric signal.

The outputter 170 includes circuitry, and the processor 130 may output various functions that can be performed by the electronic apparatus 100 through the outputter 170. Also, the outputter 170 may include at least one of a speaker or an indicator. The outputter 170 may include the display 110, but as the display 110 was explained above in the explanation regarding FIG. 2, overlapping explanation regarding the same content will be omitted. The speaker may output audio data by control by the processor 130, and the indicator may be turned on by control by the processor 130.

According to one or more embodiments, if the user's command is input through a keyboard connected to the electronic apparatus 100, the processor 130 may receive the user's command by receiving a signal corresponding to the characters input by the user through the keyboard inputter.

According to one or more embodiments, if the user's command is input through a keypad of a user terminal connected to the electronic apparatus 100, the processor 130 may receive the user's command by receiving a signal corresponding to the user's input through the communicator 140.

According to one or more embodiments, in case the user's command is input through button of a remote control connected with the electronic apparatus 100, the processor 130 may receive the user's command through a module (e.g.: a Bluetooth module) different from a communication module for performing communication with an external server (e.g.: a Wi-Fi module).

According to one or more embodiments, if the user utters a user voice corresponding to a command related to displaying a UI, the electronic apparatus 100 may receive the user voice through the microphone of the electronic apparatus 100, or receive information on the user voice received through a microphone of the remote control connected with the electronic apparatus 100 and/or a microphone of the user terminal connected with the electronic apparatus 100 from the remote control or the user terminal through the communicator. In this case, an analog voice signal received through the microphone of the electronic apparatus 100, the microphone of the remote control connected with the electronic apparatus 100, and/or the microphone of the user terminal connected with the electronic apparatus 100 may be converted into a digital signal, and then transmitted to the electronic apparatus 100. The processor 130 may obtain the user's input by receiving the user voice converted into the digital signal through the communicator 140.

According to one or more embodiments, in case a user input is received in a form of a voice signal, the processor 130 may obtain information on the user's input by obtaining text information corresponding to the voice signal by using a voice recognition model (an automatic speech recognition (ASR) model) included in the electronic apparatus 100 or a voice recognition model included in an external server.

FIGS. 4A to 4D are diagrams illustrating home UIs 20 in various forms that are displayed according to a user input according to at least one embodiment of the disclosure.

FIG. 4A is a diagram illustrating a method of receiving a user input according to at least one embodiment of the disclosure.

The electronic apparatus 100 may receive inputs corresponding to various kinds of operations from the user. For example, the electronic apparatus 100 may receive an input corresponding to playback of a video, an input corresponding to displaying of a home UI, or an input corresponding to moving of the indicator from the user. Other than the above, the electronic apparatus 100 may receive inputs corresponding to various operations of the electronic apparatus 100.

The electronic apparatus 100 may receive a user input directly through the inputter 160, or receive a user input through various external devices. For example, the electronic apparatus 100 may receive a user input from a user terminal device 410 through the communicator 140. As an example of the user terminal device 410, there may be a mobile phone, but the disclosure is not limited thereto. If a user input is input through a keypad of the user terminal device 410 or an application, the electronic apparatus 100 may receive a signal corresponding to the user input through the communicator 140.

Also, the electronic apparatus 100 may receive a user input through a button of the connected remote control 420, or receive a user input corresponding to moving of the indicator by receiving information on a tilt and a movement of the remote control 420 that was measured through a sensor included in the remote control 420. The remote control 420 may perform communication with the electronic apparatus 100 by an RF communication method or a Bluetooth method.

In addition, in case the user utters a voice corresponding to a command, the user's voice may be received through the microphone included inside the electronic apparatus 100, the microphone of the remote control 420 connected with the electronic apparatus 100, or a microphone of an AI speaker 430 separately provided, and then transmitted to the electronic apparatus 100. Here, the received user's voice may be converted into text information through a voice recognition model included in the electronic apparatus 100 or an external server, and the user's command may be obtained.

The aforementioned command for displaying the home UI may be input through devices such as the user terminal device 410, the remote control 420, and the AI speaker 430, etc. illustrated in FIG. 4. In the case of the remote control 420, one of the plurality of keys may be implemented as a dedicated key for a home UI. When the key is selected, the remote control 420 may transmit a signal including a remote control code for making the home UI displayed to the electronic apparatus 100.

In FIG. 4, it is illustrated that the electronic apparatus 100 receives input of the user's command through the user terminal device 410, the remote control 420, and the AI speaker 430, but the disclosure is not limited to the illustration in FIG. 4, and may include a case wherein a user command is input by an external device other than the above.

Hereinafter, various embodiments of the home UI 20 will be explained.

FIG. 4B is a diagram illustrating a form of the home UI 20 according to at least one embodiment of the disclosure.

When the electronic apparatus 100 receives a user input, the electronic apparatus 100 may overlay the home UI 20 on a playback screen or a still screen corresponding to the video 10 and output it. The home UI 20 may include a recent screen area 21, a recommendation area, an executable application area, a search area, and a setting area.

If the electronic apparatus 100 receives a user input while reproducing the video 10, the electronic apparatus 100 may overlay the home UI 20 on the playback screen of the video 10 and output it.

Alternatively, if the electronic apparatus 100 receives a user input after the video 10 is stopped, the electronic apparatus 100 may overlay the home UI 20 on the still screen corresponding to the video 10 and output it.

Here, the electronic apparatus 100 may output the playback screen or the still screen corresponding to the video 10 in the recent screen area 21 included in the home UI 20 based on whether the video 10 is played on the time point when the user input is received.

If the indicator is located on the recent screen area 21 during a predetermined time or longer, the electronic apparatus 100 may output the playback screen or the still screen corresponding to the video 10 instead of the home UI 20 that was overlaid.

FIG. 4C is a diagram illustrating a form of the home UI 20 according to another embodiment of the disclosure.

If the electronic apparatus 100 receives a user input, the electronic apparatus 100 may output the home UI 20 of the entire screen in place of a playback screen or a still screen corresponding to the video 10. The home UI 20 may include a recent screen area 21, a recommendation area 22, an executable application area 23, a search area, a setting area, and an advertisement area. The electronic apparatus 100 may output the plurality of areas included in the home UI 20 in tile forms.

Here, the electronic apparatus 100 may output the playback screen or the still screen corresponding to the video 10 in the recent screen area 21 included in the home UI 20 based on whether the video 10 is played on the time point when the user input is received.

If the indicator is located on the recent screen area 21 during the predetermined time o longer, the electronic apparatus 100 may output the playback screen or the still screen corresponding to the video 10 in place of the home UI 20. Here, the electronic apparatus 100 may output the playback screen or the still screen corresponding to the video 10 in an area broader than the recent screen area 20.

FIG. 4D is a diagram illustrating a form of the home UI 20 according to another embodiment of the disclosure.

When the electronic apparatus 100 receives a user input, the electronic apparatus 100 may overlay a quick menu together with the recent screen area 21 on a playback screen or a still screen corresponding to the video 10 and output it. The quick menu may be a menu that displays an area corresponding to at least one area among the plurality of areas included in the home UI 20. The electronic apparatus 100 may output a quick menu corresponding to at least one area corresponding to a user command among the recommendation area, the executable application area, the search area, and the setting area, and the recent screen area 21. The electronic apparatus 100 may receive a user input corresponding to at least one of the recommendation area, the executable application area, the search area, or the setting area from the user. For example, if the electronic apparatus 100 receives input of the remote control 420 or a button provided on the body of the electronic apparatus 100 corresponding to one of the recommendation area, the executable application area, the search area, or the setting area from the user, the electronic apparatus 100 may output an area corresponding thereto. As still another example, if the electronic apparatus 100 receives a user voice corresponding to a command for outputting one of the recommendation area, the executable application area, the search area, or the setting area, the electronic apparatus 100 may output an area corresponding thereto. Here, the electronic apparatus 100 may output the area corresponding to the user input and the recent screen area 21 together. If the indicator is located on the recent screen area 21 during the predetermined time, the electronic apparatus 100 may output a playback screen or a still screen corresponding to the video 20.

Here, if the electronic apparatus 100 receives a user input corresponding to a command for displaying the home UI while overlaying an area corresponding to the quick menu and outputting it, the electronic apparatus 100 may output the home UI 20 in place of the playback screen or the still screen corresponding to the video 20. The electronic apparatus 100 may output the home UI 20 in an area broader than the recent screen area.

Referring to FIG. 4D, the electronic apparatus 100 displays the quick menu including the recommendation area together with the recent screen area 21. The electronic apparatus 100 may display the recent screen area 21 and the quick menu by various methods. As an example, if the electronic apparatus 100 receives a user command, the electronic apparatus 100 may display the quick menu and the recent screen area 21 in a form of being displayed as going up from the bottom.

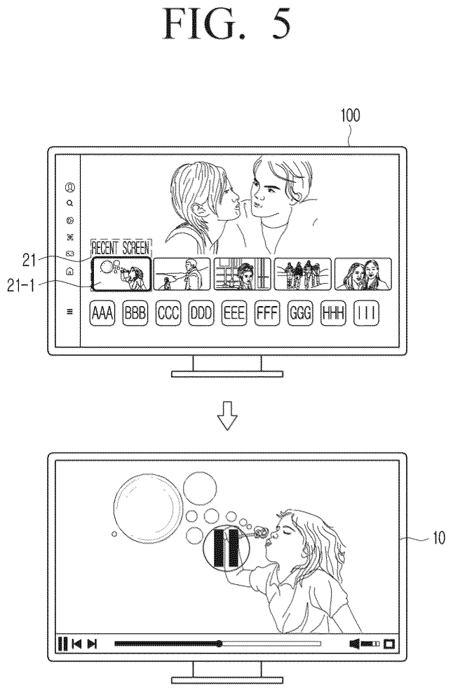

FIG. 5 is a diagram illustrating a case wherein an indicator is located on the recent screen area 21 while a playback screen is being output in the recent screen area 21 on the home UI 20 according to at least one embodiment of the disclosure.

The processor 130 may control the display 110 to output a home UI including the recent screen area based on a user input. FIG. 5 illustrates the home UI 20 including the recent screen area 21.

If the indicator is located on the recent screen area 21 during the predetermined time while a video is being played in the recent screen area 21 on the home UI 20, the processor 130 may control the display 110 to output a playback screen corresponding to the video played in the recent screen area 210 in an area broader than the recent screen area 21.

Referring to FIG. 5, a video is being played in the recent screen area 21. As the indicator is located on the recent screen area 21, the rim of the area is illustrated to be thick. If the state wherein the indicator is located on the recent screen area 21 was maintained during the predetermined time or longer, and the video was being played in the recent screen area 21, the processor 130 may control the display 110 to output a playback screen 21-1 corresponding to the video in an area broader than the recent screen area 21. The processor 130 may control the display 110 to convert the home UI 20 to a background, and convert the playback screen 21-1 corresponding to the video to a foreground, and output them in an area broader than the recent screen area 21. Through this, the video can be played without a cut-off, and the viewing time of the content can be maximized, and accordingly, the profitability can be improved.

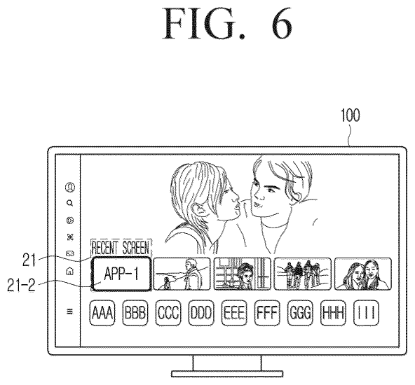

FIG. 6 is a diagram illustrating a case wherein an indicator is located on the recent screen area 21 while a replacement image is being output in the recent screen area 21 on the home UI 20 according to at least one embodiment of the disclosure.

The processor 130 may output a replacement image 21-2 or a still screen corresponding to a video in the recent screen area 21. Referring to FIG. 6, a replacement image 21-2 corresponding to a video is illustrated in the recent screen area 21. In case the video is in a temporary stop state when a user input was received, the processor 130 may output a still screen or the replacement image 21-2 corresponding to the video instead of a playback screen 21-1 corresponding to the video in the recent screen area 21. Also, in case the video was stopped when a user input was received, the processor 130 may output a still screen or the replacement image 21-2 corresponding to the video in the recent screen area 21. Here, the processor 130 may output a still screen corresponding to the screen that was being output at the time when the video was stopped in the recent screen area 21.

The replacement image 21-2 output in the recent screen area 21 may include an image related to at least one of a logo of a source that provides the video, a text, a graphic image corresponding to the source, or detailed information corresponding to the source or the video.

The replacement image 21-2 may be a form wherein a template image having a common design stored in the memory 120 and the logo or the text of the source providing the video are combined. Alternatively, the replacement image 21-2 may be a form wherein the logo of the source providing the video is combined to the background made through a graphic image generation model stored in the memory 120.

Alternatively, the processor 130 may be provided with a representative image corresponding to the video from the source providing the video, and output the replacement image 21-2 in the recent screen area 21.

Referring to FIG. 6, “APP-1” is illustrated on the replacement image 21-2, but this is merely an embodiment, and the configuration of the replacement image 21-2 is not limited to the illustration in FIG. 6.

If the indicator is located on the recent screen area 21 during the predetermined time while an image corresponding to the video is being output in the recent screen area 21, the processor 130 may control the display 110 to maintain the output of the home UI 20.

In case playback of the video was temporarily stopped or stopped before receiving a user input, the processor 130 may output the still screen or the replacement image 21-2 corresponding to the video in the recent screen area 21. In this case, the user may convert the screen to the home UI with the intent of stopping playback of the video. If the video is automatically played afterwards, a situation not intended by the user may occur. Accordingly, by maintaining the output of the home UI 20 even if the indicator is located on the recent screen area 21, automatic playback of the video that was not expected by the user can be prevented.

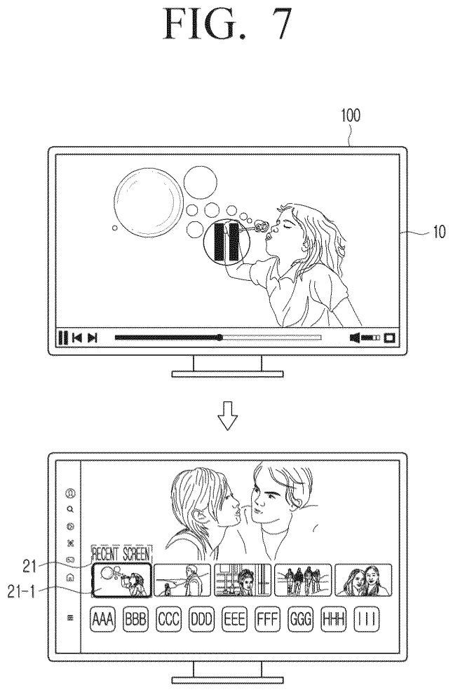

FIG. 7 is a diagram illustrating a case wherein a user input was received while a playback screen was being output according to at least one embodiment of the disclosure.

The processor 130 may control the display 110 to output the received video 10. Specifically, the user may reproduce the video by executing an application displayed on the home UI 20 of the electronic apparatus 100. Alternatively, as the indicator is located on the recent screen area 21 of the home UI 20, The processor 130 may control the display 110 to output the playback screen 21-1 corresponding to the video that is being output in the recent screen area 21 in an area broader than the recent screen area 21. FIG. 7 illustrates the electronic apparatus 100 displaying the video 10.

When a user input is received from the user, the processor 130 may identify whether the video is played.

Specifically, when a user input is received, the processor 130 may store a plurality of image frames within a specific time corresponding to the received video while the received video is being output in the memory 120. For example, the processor 130 may copy the plurality of image frames during the specific time just before the user input was received, and store them in the memory 120.

When a user input is received, the processor 130 may identify whether the video is played based on the image frames stored in the memory 120, and store the information in the memory 120. Specifically, the processor 130 may identify whether the video is played by calculating a difference among the plurality of image frames stored in the memory 120. Alternatively, the processor 130 may identify whether the video is played by generating a vector indicating the directions and the speed in which each pixel moved in two consecutive image frames and identifying the changed amount of the vector. The processor 130 may store the identified information on whether the video is played in the memory 120.

Meanwhile, the processor 130 may store audio data within a specific time among audio data included in the video while the received video is being output in the memory 120. Specifically, when a user input is received, the processor 130 may store audio data within the specific time while the video is being played in the memory 120. The audio data may include information on a frequency spectrum or amplitude of audio. For example, the processor 130 may copy audio data during a few ms just before the user input was received, and store the data in the memory 120.

When a user input is received, the processor 130 may identify whether the video is played based on the audio data stored in the memory 120, and store the information in the memory 120. Specifically, the processor 130 may identify whether the video is played by identifying whether an audio signal is detected. Alternatively, the processor 130 may analyze a frequency spectrum of an audio signal, and if the frequency spectrum is almost regular or there is no change in the frequency, the processor 130 may identify that playback of the video was stopped. As another example, the processor 130 may calculate a root mean square (RMS) value for the amplitude of an audio signal by a specific cycle, and if the RMS value is maintained to be smaller than or equal to a specific threshold value, the processor 130 may identify that playback of the video was stopped. The processor 130 may store the identified information on whether the video is played in the memory 120.

Meanwhile, the processor 130 may identify whether the video is played by analyzing the image frames and the audio data of the video described above together. In this case, with respect to the video in a form wherein only audio is played based on an image, the processor 130 may identify whether the video is played by detecting a change in the audio data although the image frames do not change.

Other than the identification method using the image frames and the audio data described above, the processor 130 may identify whether the video is played by analyzing the real time playback time updated in the network traffic or in an application.

Also, identification of whether the video is played may be performed by the processor 130, but it may also be performed through an identification model included in an external server. Specifically, the processor 130 may transmit the image frames or the audio data obtained from the video to an external server through the communicator. The processor 130 may receive the information on whether the video is played identified through the identification model included in the external server through the communicator.

The processor 130 may store the information on whether the video is played identified by the above method in the memory 120. The processor 130 may store the results analyzed by the respective methods in the memory 120 by dividing them. Specifically, the processor 130 may store an analysis result through the image frames and an analysis result through the audio data by dividing them. In this case, displaying of the recent screen area 21 and whether to automatically re-execute the video may be determined in various ways through the results stored in a divided manner. For example, in case the video is being played but the audio is not being played, the processor 130 may set such that the video is not automatically re-executed. This is because, in such a case, the possibility that the user may not expect that the playback screen 21-1 would be converted into the entire screen is relatively higher than a case wherein both of the video and the audio are being played.

If a user input is received while a playback screen corresponding to the received video is being output, the processor 130 may control the display 110 to output the home UI 20 in an area broader than the recent screen area 21, and output the playback screen 21-1 corresponding to the received video in the recent screen area 21.

Referring to FIG. 7, if a user input is received while the video is being played, and it is identified that the video is being played, the processor 130 may control the display 110 to output the home UI 20 and output the playback screen 21-1 corresponding to the video in the recent screen aera 21 on the home UI 20. The playback screen 21-1 corresponding to the video may be displayed from an image frame on the time point when the user input was received, or it may be output from an image frame that is prior to the screen on the time point when the user input was received by a specific time.

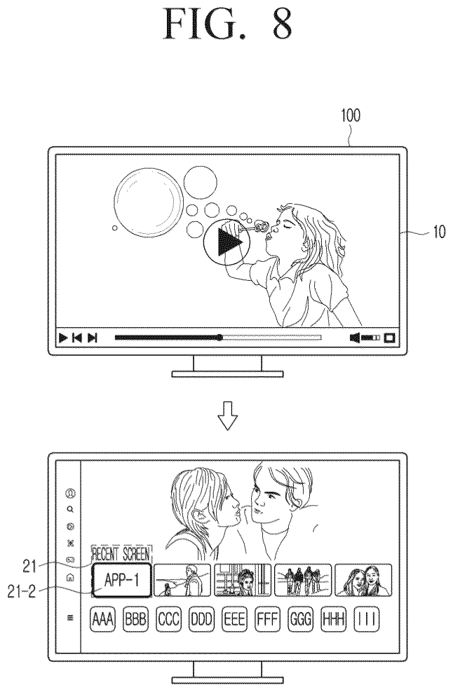

FIG. 8 is a diagram illustrating a case wherein a user input was received while a still screen was being output according to at least one embodiment of the disclosure.

If a user input is received while a still screen corresponding to a received video is being output, the processor 130 may control the display 110 to output the home UI 20 in an area broader than the recent screen area 21, and output a still screen or a replacement image 21-2 corresponding to the received video in the recent screen area 21.

Referring to FIG. 8, if a user input is received while the video is temporarily stopped, and it is identified that the video is not being played, the processor 130 may control the display 110 to output the home UI 20, and output the still screen or the replacement image 21-2 corresponding to the video in the recent screen area 21 on the home UI 20. On the still screen corresponding to the video, an image frame on the time point when the user input was received may be displayed, or an image frame that is prior to the screen on the time point when the user input was received by a specific time may be displayed.

Meanwhile, while the processor 130 displays the home UI 20 after receiving a user input, identification of whether the video is played may not be completed.

While identifying whether the video is played, the processor 130 may control the display 110 to output the replacement image 21-2 corresponding to the video in the recent screen area 21.

This is for making the home UI 20 displayed immediately according to a user input even if identification of whether the video is played becomes late.

Afterwards, when identification of whether the video is played is completed, the processor 130 may control the display 110 to output the playback screen 21-1 corresponding to the received video in the recent screen area 21, or output the still screen or the replacement image 21-2 corresponding to the received video in the recent screen area 21 according to whether the received video is played.

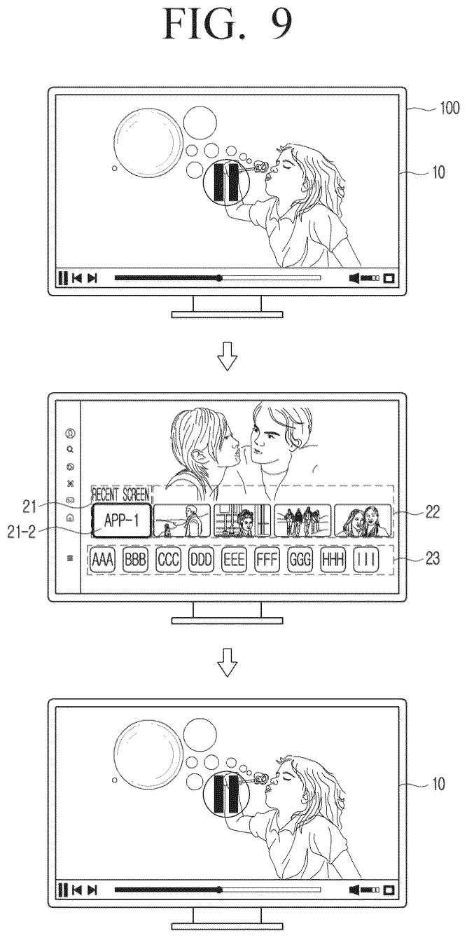

FIG. 9 is a diagram illustrating a case wherein an application related to playback of a video does not support a function corresponding to screen size adjustment according to at least one embodiment of the disclosure.

In case a video was being played when a user input was received, but the video cannot be played on a small screen, a still screen or a replacement image 21-2 corresponding to the video may be displayed in the recent screen area 21.

If an application related to playback of a video does not support a function corresponding to screen size adjustment, the processor 130 may control the display 110 to output the home UI 20 based on the user input while the playback screen corresponding to the received video is being output through the application, and output an image 21-2 corresponding to the application in the recent screen area 21.

The function corresponding to screen size adjustment may be a function that makes an application adjust a screen size to be small and play a video on a small screen. A screen size of a video may be adjusted to be small and the video may be played in a specific area, or a video may float on another application screen and the location of the playback screen 21-1 may be moved freely. According to an embodiment of the disclosure, a screen size of a video may be adjusted to be small and the video may be played in the recent screen area 21 of the home UI 20. The function corresponding to screen size adjustment may alternatively mean a picture-in-picture (PIP) function.

The application related to playback of a video may not support the function corresponding to screen size adjustment. The application may not support the function corresponding to screen size adjustment by a policy. In this case, even if the home UI 20 is displayed while a video is being played, the playback screen 21-1 corresponding to the video cannot be displayed in the recent screen area 21. The processor 130 may control the display 110 to display the replacement image 21-2 for the application in the recent screen area 21. FIG. 9 illustrates a case wherein, in case the home UI 20 is displayed while a video is being played, the replacement image 21-2 is displayed in the recent screen area 21 as the application does not support the function corresponding to screen size adjustment.

In case the fact that the application does not support the function corresponding to screen size adjustment can be identified through predetermined metadata, the processor 130 may control the display 110 to display the replacement image 21-2 corresponding to the video in the recent screen area 21 of the home UI 20 according to a command for displaying the home UI while the application is being executed.

In case the fact that the application does not support the function corresponding to screen size adjustment cannot be identified through the predetermined metadata, the processor 130 may control the display 110 to display the playback screen 21-1 corresponding to the video in the recent screen area 21 of the home UI 20. Here, the processor 130 may identify whether the function corresponding to screen size adjustment is supported by analyzing the screen output in the recent screen area 21 through the display 110. For example, in case a single black screen is maintained in the recent screen area 21, or is maintained in a still state but not the playback screen corresponding to the video, the processor 130 may identify that the application does not support the function corresponding to screen size adjustment. The processor 130 may store information on whether the application supports the function corresponding to screen size adjustment in the memory 120. Afterwards, if a user input is received while the video is being played through the application, the processor 130 may control the display 110 to display the replacement image 21-2 corresponding to the video according to the information on whether the application supports the function corresponding to screen size adjustment stored in the memory 120.

While the replacement image 21-2 of the application that does not support the function corresponding to screen size adjustment is being displayed in the recent screen area 21 on the home UI 20, if the indicator is located on the recent screen area 21 during the predetermined time, the processor 130 may control the display 110 to output the playback screen 21-1 corresponding to the video played in the application in an area broader than the recent screen area 21.

FIG. 9 illustrates a case wherein focusing was maintained on the recent screen area 21 wherein the replacement image 21-2 is displayed, and the playback screen 21-1 was output in an area broader than the recent screen area 21.

The processor 130 may identify that the video was being played when a user input was received through the information on whether the video is played stored in the memory 120, and control the display 110 to output the playback screen 21-1 corresponding to the video in an area broader than the recent screen area 21.

As the user input a command for displaying the home UI while the video was being played, playback of the video can be expected even though the application is executed automatically in the state of the home UI 20.

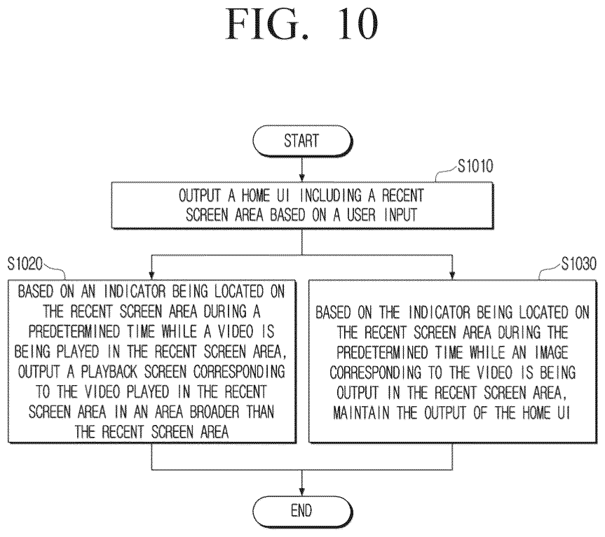

FIG. 10 is a flow chart illustrating a control method of the electronic apparatus 100 according to at least one embodiment of the disclosure.

According to FIG. 10, the electronic apparatus 100 displays a home UI 20 including a recent screen area 21 based on a user input in the operation S1010.

The home UI 20 may include the recent screen area 21. In the recent screen area 21, information on a video that was being played before the home UI 20 was displayed may be displayed. Alternatively, information on a video that was being played when a command for displaying the home UI was input may be displayed. Also, the home UI 20 may consist of a plurality of display areas other than the recent screen area 21. For example, the plurality of display areas may include a recommendation area 22, an executable application area 23, a search area, a setting area, etc. Meanwhile, the configuration and the arrangement of the home UI 20 illustrated in FIG. 1 merely fall under one embodiment, and the home UI 20 is not limited thereto, and may include various configurations and arrangements.

If an indicator is located on the recent screen area 21 during a predetermined time while the video is being played in the recent screen area 21, the electronic apparatus 100 outputs a playback screen 21-1 corresponding to the video played in the recent screen area 21 in an area broader than the recent screen area 21 in the operation S1020.

If the indicator is located on one area among the plurality of areas included in the home UI 20, the one area may be displayed to be distinctive compared to the ambient areas. For example, in case one area on the home UI 20 is selected or emphasized as the indicator is located on it, the size of the area may increase compared to the other areas, or the thickness of the rim of the area may become thick or may be displayed in a different color.

If the state wherein the indicator is located on the recent screen area 21 is maintained during the predetermined time or longer, and the video was being played in the recent screen area 21, the electronic apparatus 100 may output the playback screen 21-1 corresponding to the video played in the recent screen area 21 in an area broader than the recent screen area 21.

If the indicator is located on the recent screen area 21 during the predetermined time while an image corresponding to the video is being output in the recent screen area 21, the electronic apparatus 100 maintains the output of the home UI 21 in the operation S1030.

In case the video is in a temporary stop state when a user input was received, the electronic apparatus 100 may display a still screen or a replacement image 21-2 corresponding to the video in the recent screen area 21. Also, in case the video was stopped when a user input was received, the electronic apparatus 100 may output a still screen or the replacement image 21-2 corresponding to the video in the recent screen area 21.

The replacement image 21-2 displayed in the recent screen area 21 may include an image related to at least one of a logo of a source that provides the received video, a text, a graphic image corresponding to the source, or detailed information corresponding to the source or the video.

In case the user temporarily stopped or stopped playback of the video before inputting a command for displaying the home UI, the still screen or the replacement image 21-2 corresponding to the video may be displayed in the recent screen area 21. In this case, the user may have converted the screen to the home UI 20 with the intent of stopping playback of the video. If the video is automatically played afterwards, a situation not intended by the user may occur. Accordingly, by maintaining the output of the home UI 20 even if the indicator is located on the recent screen area 21, automatic playback of the video that was not expected by the user can be prevented.

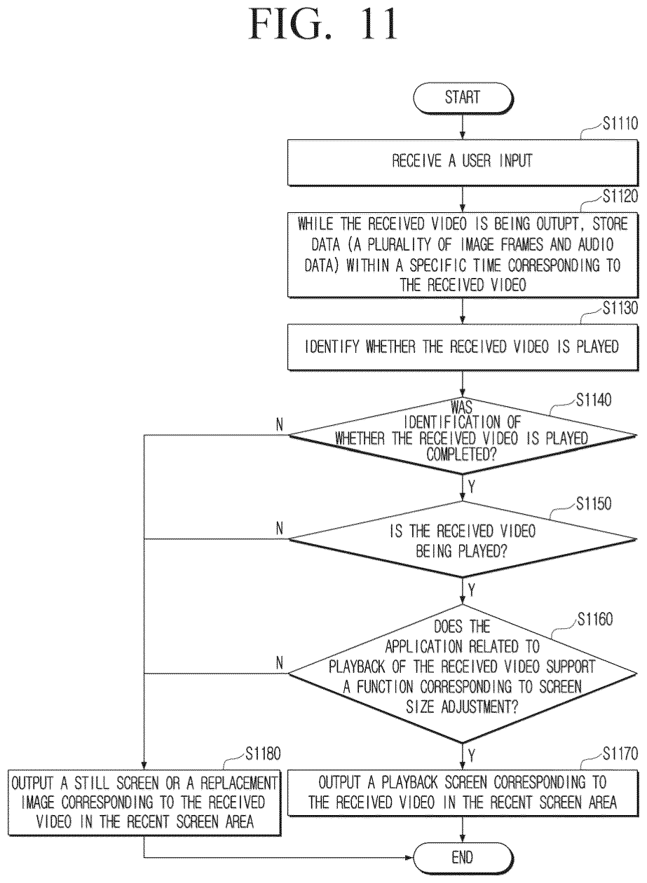

FIG. 11 is a flow chart for illustrating in detail a method of displaying the home UI 20 including the recent screen area 21 in the electronic apparatus 100 according to at least one embodiment of the disclosure.

The electronic apparatus 100 may receive a user input in the operation S1110.

The user input may include a command for displaying the home UI of the user. The user input may be directly input through the electronic apparatus 100, or may be transmitted through various external devices. For example, the user's input may be transmitted to the electronic apparatus 100 through a user terminal device 410, a remote control 420, or an AI speaker 430. As detailed explanation regarding the method for transmitting the user's input to the electronic apparatus 100 was explained in FIG. 4, explanation in that regard will be omitted.

The electronic apparatus 100 may store data within a specific time corresponding to the received video while the received video is being output in the operation S1120. Here, in the data stored by the electronic apparatus 100, a plurality of image frames or audio data during the specific time before the time point when the user input was received may be included.

The electronic apparatus 100 may identify whether video is played in the operation S1130. Specifically, the electronic apparatus 100 may identify whether the video is played based on the data within the specific time corresponding to the video. The electronic apparatus 100 may identify whether the video is played by analyzing a difference of consecutive image frames or a change of pixel vectors. Alternatively, the electronic apparatus 100 may identify whether the video is played by analyzing a frequency spectrum or amplitude of an audio signal in the audio data.

Meanwhile, identification of whether the video is played may be performed through an identification model stored in the electronic apparatus 100, but it may also be performed through an identification model stored in an external server connected with the electronic apparatus 100. Here, the electronic apparatus 100 may transmit the data of the video to the external server, and receive information on whether the video is played from the external server.

In case identification of whether the video is played was not completed in the operation S1140-N, the electronic apparatus 100 may output a still screen or a replacement image 21-2 corresponding to the received video in the recent screen area 21 in the operation S1180.

Even if identification of whether the video is played becomes late, the electronic apparatus 100 may output the still screen or the replacement image 21-2 corresponding to the video in the recent screen area 21 so that the home UI 20 can be displayed immediately according to a user input.

In case identification of whether the video is played was completed in the operation S1140-Y, the electronic apparatus 100 may output a playback screen or output the still screen or the replacement image 21-2 in the recent screen area 21 according to the identification result.

In case the video is not being played as a result of identifying whether the video is played in the operation S1150-N, the electronic apparatus 100 may output the still screen or the replacement image 21-2 corresponding to the video in the recent screen area 21 in the operation S1180.

In case the video is being played as a result of identifying whether the video is played in the operation S1150-Y, the electronic apparatus 100 may output the playback screen or output the still screen or the replacement image 21-2 in the recent screen area 21 according to whether the application related to playback of a video supports a function corresponding to screen size adjustment.

The function corresponding to screen size adjustment may be a function that makes the application related to playback of a video adjust a screen size to be small and play a video on a small screen. The application related to playback of a video may not support the function corresponding to screen size adjustment. Alternatively, the application related to playback of a video may not support the function corresponding to screen size adjustment by a policy.

In case the application related to playback of a video does not support the function corresponding to screen size adjustment in the operation S1160-N, the electronic apparatus 100 may output the still screen or the replacement image 21-2 corresponding to the video in the recent screen area 21 in the operation S1180.

The electronic apparatus 100 may output the still screen or the replacement image 21-2 corresponding to the video since the playback screen 21-1 corresponding to the video cannot be output in the recent screen area 21 even through the video was being played.

In case the application related to playback of a video supports the function corresponding to screen size adjustment in the operation S1160-Y, the electronic apparatus 100 may output the playback screen 21-1 corresponding to the video in the recent screen area 21 in the operation S1170.

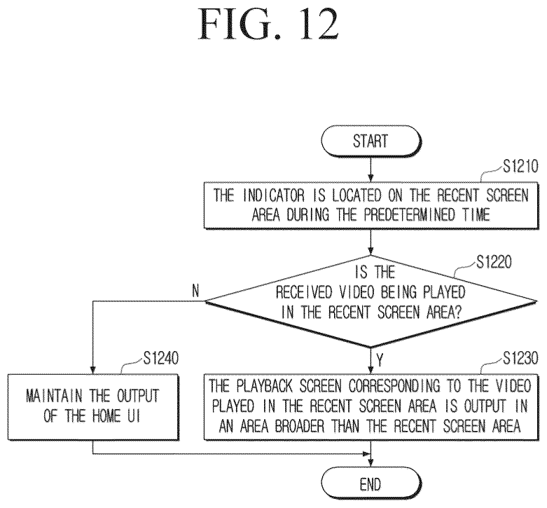

FIG. 12 is a flow chart illustrating an operation of the electronic apparatus 100 in case an indicator is located on the recent screen area 21 of the home UI 20 according to at least one embodiment of the disclosure.

An indicator may be located on the recent screen area 21 of the home UI 20 during a predetermined time or longer in the operation S1210.

The user may locate the indicator on one of a plurality of areas on the home UI 20. If the indicator is located on one area among the plurality of areas on the home UI 20 through an input device, one area among the plurality of areas on the home UI 20 may be selected or emphasized. The electronic apparatus 100 may locate the indicator by receiving an input for the indicator through a remote control, a touch pad, or an AI speaker, etc. from the user.

The user may move the indicator with respect to the plurality of areas on the home UI 20, and then locate the indicator on the recent screen area 21 during the predetermined time. For example, the user may locate the indicator on the recent screen area 21 for one minute or longer. In this case, the electronic apparatus 100 may vary whether the video will be automatically executed according to the state of the screen that is being output in the recent screen area 21.

In case a playback screen 21-1 corresponding to the video is being output in the recent screen area 21 in the operation S1220-Y, the electronic apparatus 100 may output the playback screen 21-1 corresponding to the video in an area broader than the recent screen area 21 in the operation S1230. Through this, the video can be played without a cut-off, and the viewing time of the content can be maximized, and accordingly, the profitability can be improved.

In case a replacement image 21-2 or a still screen corresponding to the video is displayed in the recent screen area 21 in the operation S1220-N, the electronic apparatus 100 may maintain the output of the home UI 20 in the operation S1240. Through this, automatic playback of the video that was not expected by the user can be prevented.

The aforementioned various embodiments may be implemented solely as individual embodiments, but the disclosure is not necessarily limited thereto, and the embodiments may be implemented together with at least one other embodiment by being combined with them partially or on the whole.

Also, the methods according to the aforementioned various embodiments of the disclosure may be implemented just with software upgrade, or hardware upgrade of conventional electronic apparatuses 100.

Meanwhile, according to an embodiment of the disclosure, the control method according to the aforementioned various embodiments may be implemented as software including instructions stored in a non-transitory computer-readable recording medium, which can be read by various machines (e.g.: computers) such as the electronic apparatus 100.

Specifically, a program for performing the control method including outputting a home UI including a recent screen area based on a user input, and based on an indicator being located on the recent screen area during a predetermined time while a video is being played in the recent screen area, outputting a playback screen corresponding to the video played in the recent screen area in an area broader than the recent screen area, and based on the indicator being located on the recent screen area during the predetermined time while an image corresponding to the video is being output in the recent screen area, maintaining the output of the home UI may be provided while being stored in a non-transitory computer-readable recording medium.

In case the stored software or instructions are executed by the processor 130, the processor 130 may perform operations according to the aforementioned various embodiments directly, or by using other components. An instruction may include a code that is generated or executed by a compiler or an interpreter. Here, the term ‘non-transitory’ only means that a storage medium does not include signals, and is tangible, and the term does not distinguish a case wherein data is stored semi-permanently in a storage medium and a case wherein data is stored temporarily.

Also, according to an embodiment, the method according to the aforementioned various embodiments may be provided while being included in a computer program product. A computer program product refers to a product, and it can be traded between a seller and a buyer. A computer program product can be distributed on-line not only through the aforementioned non-transitory computer-readable recording medium, but also through an on-line store. In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a display;
a memory to store at least one instruction; and
a processor, based on execution of the at least one instruction, configured to:
control the display to output a home user interface (UI) including a recent screen area displaying a video, based on a user input,
based on an indicator being associated with the recent screen area during a predetermined time while the video is being played in the recent screen area, control the display to output, in an area broader than the recent screen area, a playback screen corresponding to the video played in the recent screen area, and
based on the indicator being associated with the recent screen area during the predetermined time while an image corresponding to the video is being output in the recent screen area, control the display to maintain the output of the home UI.

2. The electronic apparatus of claim 1,
wherein the processor is configured to:
control the display to output a received video,
based on receiving the user input while a playback screen corresponding to the received video is being output, control the display to output the home UI in the area broader than the recent screen area and output the playback screen corresponding to the received video in the recent screen area, and
based on receiving the user input while a still screen corresponding to the received video is being output, control the display to output the home UI in the area broader than the recent screen area and output the still screen corresponding to the received video or a replacement image in the recent screen area.

3. The electronic apparatus of claim 2,
wherein the processor is configured to:
store a plurality of image frames within a specific time corresponding to the received video in the memory while the received video is being output, and
based on receiving the user input, identify whether the received video is played based on the plurality of image frames stored in the memory.

4. The electronic apparatus of claim 2,
wherein the processor is configured to:
store audio data within a specific time among the audio data included in the received video in the memory while the received video is being output, and
based on receiving the user input, identify whether the received video is played based on the audio data stored in the memory.

5. The electronic apparatus of claim 3,
wherein the processor is configured to:
while identifying whether the received video is played, control the display to output the replacement image corresponding to the received video in the recent screen area, and
based on whether the received video is identified to be played, control the display to output the playback screen corresponding to the received video in the recent screen area or output the still screen or the replacement image corresponding to the received video.

6. The electronic apparatus of claim 1,
wherein the processor is configured to:
control the display to output a received video, and
based on a function corresponding to screen size adjustment being unsupported by an application related to playback of the received video, control the display to output the home UI based on the user input while the playback screen corresponding to the received video is being output through the application, and control the display to output an image corresponding to the application in the recent screen area.

7. The electronic apparatus of claim 6,
wherein the processor is configured to:
while the image corresponding to the application is being output in the recent screen area included in the home UI, based on the indicator being associated with the recent screen area during the predetermined time, control the display to output the playback screen corresponding to the received video in the area broader than the recent screen area through the application.

8. The electronic apparatus of claim 1,
wherein a replacement image is output in the recent screen area, the replacement image being related to at least one of a logo of a source that provides the video, a text, a graphic image corresponding to the source, or detailed information corresponding to the source or the video.

9. A control method of an electronic apparatus, the control method comprising:
outputting a home UI including a recent screen area displaying a video, based on a user input;
based on an indicator being associated with the recent screen area during a predetermined time while the video is being played in the recent screen area, outputting, in an area broader than the recent screen area, a playback screen corresponding to the video played in the recent screen area; and
based on the indicator being associated with the recent screen area during the predetermined time while an image corresponding to the video is being output in the recent screen area, maintaining the output of the home UI.

10. The control method of claim 9,
wherein the control method comprises:
outputting a received video, and
the outputting the home UI comprises:
based on receiving the user input while a playback screen corresponding to the received video is being output, outputting the home UI in the area broader than the recent screen area and outputting the playback screen corresponding to the received video in the recent screen area; and
based on receiving the user input while a still screen corresponding to the received video is being output, outputting the home UI in the area broader than the recent screen area and outputting the still screen corresponding to the received video or a replacement image in the recent screen area.

11. The control method of claim 10,
wherein the outputting the home UI further comprises:
storing a plurality of image frames within a specific time corresponding to the received video while the received video is being output; and
based on receiving the user input, identifying whether the received video is played based on the stored plurality of image frames.

12. The control method of claim 10,
wherein the outputting the home UI further comprises:
storing audio data within a specific time among the audio data included in the received video while the received video is being output; and
based on receiving the user input, identifying whether the received video is played based on the stored audio data.

13. The control method of claim 11,
wherein the outputting the home UI further comprises:
while identifying whether the received video is played, outputting the replacement image corresponding to the received video in the recent screen area; and
based on whether the received video is identified to be played, outputting the playback screen corresponding to the received video in the recent screen area or outputting the still screen or the replacement image corresponding to the received video.

14. The control method of claim 9,
wherein the control method comprises:
outputting a received video, and
wherein the outputting the home UI comprises:
based on a function corresponding to screen size adjustment being unsupported by an application related to playback of the received video, outputting the home UI based on the user input while the playback screen corresponding to the received video is being output through the application, and outputting an image corresponding to the application in the recent screen area.

15. The control method of claim 14, further comprising:
while the image corresponding to the application is being output in the recent screen area included in the home UI, based on the indicator being associated with the recent screen area during the predetermined time, outputting the playback screen corresponding to the received video in the area broader than the recent screen area through the application.

16. The control method of claim 9,
wherein a replacement image is output in the recent screen area, the replacement image being related to at least one of a logo of a source that provides the video, a text, a graphic image corresponding to the source, or detailed information corresponding to the source or the video.

17. A non-transitory computer-readable recording medium including a program for executing a control method for an electronic apparatus, wherein the method comprises:
outputting a home UI including a recent screen area displaying a video, based on a user input;
based on an indicator being associated with the recent screen area during a predetermined time while the video is being played in the recent screen area, outputting, in an area broader than the recent screen area, a playback screen corresponding to the video played in the recent screen area; and
based on the indicator being associated with the recent screen area during the predetermined time while an image corresponding to the video is being output in the recent screen area, maintaining the output of the home UI.

18. The non-transitory computer-readable recording medium of claim 17,
wherein the control method comprises:
outputting a received video, and
the outputting the home UI comprises:
based on receiving the user input while a playback screen corresponding to the received video is being output, outputting the home UI in the area broader than the recent screen area and outputting the playback screen corresponding to the received video in the recent screen area; and
based on receiving the user input while a still screen corresponding to the received video is being output, outputting the home UI in the area broader than the recent screen area and outputting the still screen corresponding to the received video or a replacement image in the recent screen area.

19. The non-transitory computer-readable recording medium of claim 18,
wherein the outputting the home UI further comprises:
storing a plurality of image frames within a specific time corresponding to the received video while the received video is being output; and
based on receiving the user input, identifying whether the received video is played based on the stored plurality of image frames.

20. The non-transitory computer-readable recording medium of claim 18,
wherein the outputting the home UI further comprises:
storing audio data within a specific time among the audio data included in the received video while the received video is being output; and
based on receiving the user input, identifying whether the received video is played based on the stored audio data.
